(19) United States
(12) Patent Application Publication
(10) Pub. No.: US 2025/0347502 A1
(43) Pub. Date: Nov. 13, 2025

(54) Flex Shaft Locating Device

(71) Applicant: Landon Cole Brecheisen, Hugoton, KS (US)

(72) Inventor: Landon Cole Brecheisen, Hugoton, KS (US)

(21) Appl. No.: 18/661,671

(22) Filed: May 12, 2024

(51) Int. Cl. G01B 3/00

(52) U.S. Cl. CPC G01B 3/002

(57) ABSTRACT

A flex shaft locating device is presented with a unique arrangement of parts. The device utilizes a flex shaft affixed with a mounting arm for affixing a measuring device and then is used to detect the shaft flex when contacting a workpiece. This approach for use in machine tool operation and machining approaches related to finding location of workpieces in a precise manner. Flex shaft locating device may use a variety of attachments or flex shaft forms allowing the same working principle of the device, but allowing more capability of workpiece locating, such as edges, round centers, holes, marks, countersinks, protruding locating pins, and so on. The flex shaft locating device is a standalone device constructed as a complete arrangement of parts and purpose built for the use of locating workpieces.

### BRIEF DESCRIPTION OF THE DRAWINGS

NOTE: For simplicity of illustration, industry hardware and part shape or forms are not necessarily depicted for attachment methods as they are known to those with skill in the art. When they are shown, it is purely for illustrative purposes and not intended to capture all embodiments of invention disclosed.

FIG. 1 is a front view of flex shaft locating device 10

FIG. 2 is an isometric view of flex shaft locating device 10

FIG. 3 is a front view of flex shaft locating device 10 and workpiece 60

FIG. 4 is a front view of flex shaft locating device 10 with indirect mount 30

FIG. 5 is an isometric view of flex shaft locating device 10 with indirect mount 30

FIG. 10 is a front view of a round flex shaft 110

FIG. 11 is a front view of a reduced tip flex shaft 111

FIG. 12 is a front view of a large tip flex shaft 112

FIG. 13 is a front view of a reduced area tip flex shaft 113

FIG. 14 is a front view of a large ball tip flex shaft 114

FIG. 15 is a front view of a reduced area ball tip flex shaft 115

FIG. 16 is a front view of a half round ball tip flex shaft 116

FIG. 17 is a front view of a round edge flex shaft 117

FIG. 18 is a front view of a cone point tip flex shaft 118

FIG. 19 is a front view of a chamfer tip flex shaft 119

FIG. 20 is a front view of a disk-shaped tip flex shaft 120

FIG. 21 is a front view of a cup end tip flex shaft 121

FIG. 22 is a front view of a directly on edge tip flex shaft 122

FIG. 23 is a bottom view of a directly on edge tip flex shaft 122

FIG. 24 is a front view of a directly on edge sweeping radius tip flex shaft 124

FIG. 25 is a bottom view of a directly on edge sweeping radius tip flex shaft 124

FIG. 26 is a front view of a large cone tip flex shaft 126

FIG. 27 is a front view of an inverted cone tip flex shaft 127

FIG. 28 is a front view of a bar shaped disk tip flex shaft 128

FIG. 29 is a front view of a vee shaped tip flex shaft 129

FIG. 30 is a front view of a polygon tip and flex shaft 130

FIG. 31 is a bottom view of a polygon tip and flex shaft 130

FIG. 32 is a front view of a reduced areas flex shaft 132

FIG. 33 is a front view of a large shank flex shaft 133

FIG. 34 is a front view of a reduced flex shaft 134

### DETAILED DESCRIPTION

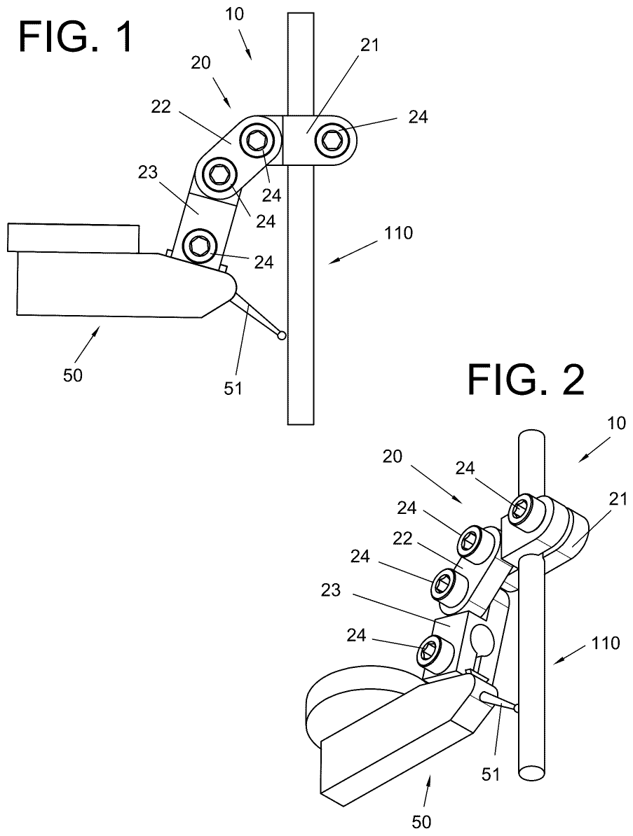

Referring to the drawings, and more particularly to FIGS. 1 and 2 thereof, there is shown a flex shaft locating device 10. Device is configured as follows, flex shaft 110 has attachment with the mounting arm 20 with mount 21, fasteners 24 being used to tighten mount 21 to make an attachment to the flex shaft 110, the overall construction of mounting arm 20 continues with the link piece 22, which attaches with fasteners 24 to measuring device 50, mount 23 is mounting the measuring device 50. The contact tip 51 of measuring device 50 is put in contact with the flex shaft 110.

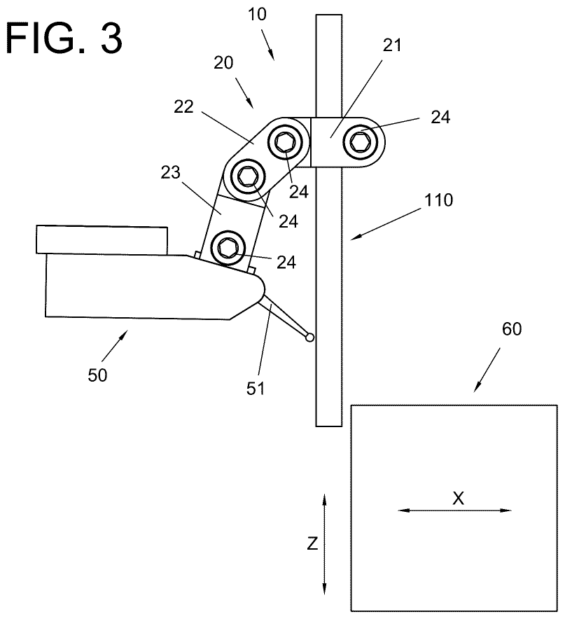

Shown in FIG. 3 the flex shaft locating device 10 is illustrated along with an outline of a workpiece 60. It is common knowledge for those with skill in the art how a machine tool is operated. The machine tool uses a coordinate system with a moving axis in X, Y, and Z, which allows the machine tool to travel around in 3d space, thus allowing a tool to come in contact with a workpiece. It is illustrated in FIG. 3 the travel of the machine tool axis will be in the X or Z axis. The X axis will be noted as moving in this illustration to bring the flex shaft locating device 10 in contact with the workpiece 60. The flex shaft locating device 10 is mounted in a machine tool. The operator of the machine tool will move the machine tool axis to bring flex shaft locating device 10 into contact with the workpiece 60. The contact between the flex shaft 110 and the workpiece 60 will result in measurement to be detected by the measuring device 50 and noticed by the operator. Measuring device 50 is to be in contact with flex shaft 110 with the contact point of the measuring device 51. When measurement is noticed, the operator will stop moving the machine tool axis and the location of the workpiece 60 is established. Different approaches can be used, such as adjusting the measurement until it is on a certain number on the measuring device 50. The operator may place a hand force on the flex shaft 110, which prevents the operator from overshooting the correct measurement location on the workpiece 60.

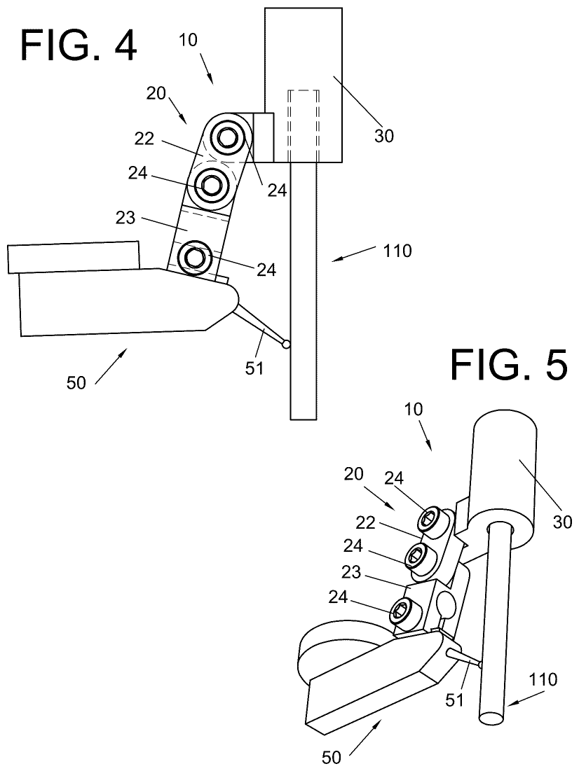

Shown in FIG. 1 and FIG. 2 the flex shaft locating device 10 built with an arm 20 for adjustability and compatibility with different measuring devices, however flex shaft locating device 10 may be configured differently to allow a different arrangement of parts, which may dictate the flex shaft locating device 10 to a certain measuring device. Mounting arm 20 may be constructed as an assembly or single piece construction, for reducing part count, however still keeping the working ability of flex shaft locating device 10. The flex shaft locating device 10 has the mounting arm 20 directly attached to the flex shaft 110, however flex shaft locating device 10 may be constructed with the arm 20 indirectly attached with indirect mount 30 to flex shaft 110, which is depicted in FIG. 4 and FIG. 5 The flex shaft locating device 10 may be constructed with either a direct or indirect mount. This means the attachment of mounting arm 20 is either directly or indirectly connected to flex shaft 110.

It is to be understood that the flex shaft 110 is usually constructed having a straight axis, however flex shaft may have a curved axis to allow the ability to project around objects or workpieces. It shall be noted flex shaft 110 usually constructed from tool steel having material properties allowing shaft to flex when flex shaft 110 comes into contact with a workpiece and thus returns back to the same repeatable position for measurement purpose. Flex shaft locating device 10 would not function correctly if material properties of flex shaft 110 are not able to allow returning back of flex shaft 110 to the same repeatable position for measurement purpose. Flex shaft locating device 10 may have parts, which allow the device to adjust position when held in a machine tool. Flex shaft locating device 10 may have parts, which allow adjustment of radial and or axial runout. It is to be noted the flex shaft locating device 10 may be configured in different ways, in which configured in those ways the flex shaft locating device is still maintaining the same working principle of the flex shaft locating device 10.

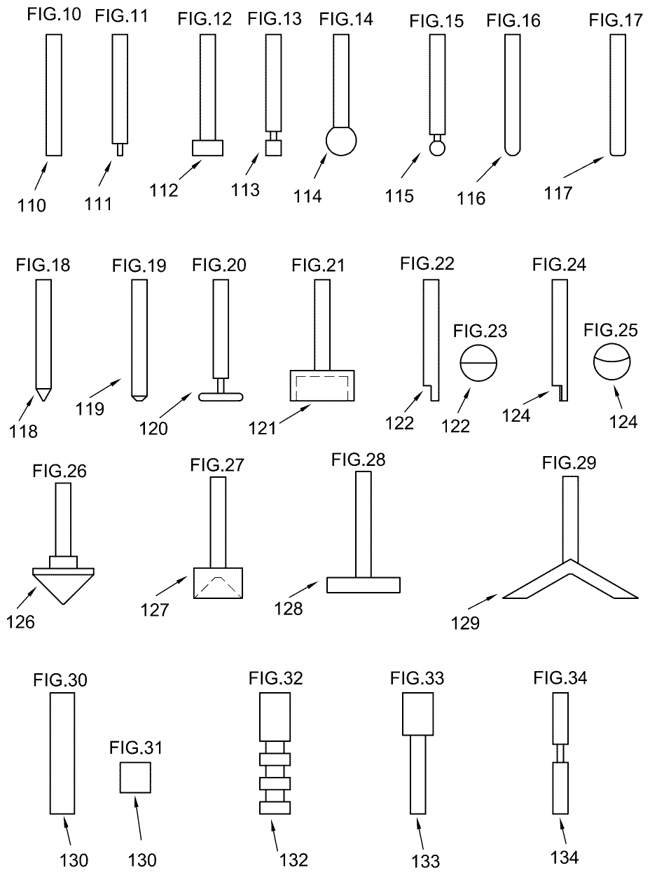

Shown in FIG. 10, through FIG. 34 are various flex shaft and or attachment configurations. The operator is able to use them by attachment or mounting to the flex shaft locating device 10. The same use of the flex shaft locating device 10 is performed, which will detect location of workpiece features with or without attachments. Measuring device 50, may be interchangeable or configured with different types of measuring and or detection devices such as, dial indicator measuring devices, electric circuit devices, light detection measuring devices, and others.

Shown in FIG. 10 the round tip flex shaft 110 formed or affixed to end of flex shaft. For edge finding with or without attachments to add functions. It can be single or multi piece construction, containing a group of parts.

Shown in FIG. 11 the reduced tip flex shaft 111 formed or affixed to end of flex shaft to reach in tight areas on workpieces.

Shown in FIG. 12 the large tip flex shaft 112 formed or affixed to end of flex shaft to be used on larger areas on workpieces.

Shown in FIG. 13 the reduced area tip flex shaft 113 formed or affixed to end of flex shaft used to prevent burred or damaged edges from affecting measurement.

Shown in FIG. 14 the large ball tip flex shaft 114 formed or affixed to end of flex shaft used to touch off edges or angled surfaces.

Shown in FIG. 15 the reduced area ball tip flex shaft 115 formed or affixed to end of flex shaft used to touch off edges, prevent burred or damaged edges from affecting measurement, and touching off angled surfaces.

Shown in FIG. 16 the half round ball tip flex shaft 116 formed or affixed to end of flex shaft used to touch off edges, holes, counter bores.

Shown in FIG. 17 the round edge tip flex shaft 117 formed or affixed to end of flex shaft used to touch off edges, holes, counter bores.

Shown in FIG. 18 the cone point tip flex shaft 118 formed or affixed to end of flex shaft used to find center punch marks and center of holes.

Shown in FIG. 19 the chamfer tip flex shaft 119 chamfer tip formed or affixed to end of flex shaft used to find the center of chamfered holes. Form may match the angle of flat head screws, typically 82 or 90 degrees.

Shown in FIG. 20 the disk-shaped tip flex shaft 120 formed or affixed to end of flex shaft used to find edges of workpieces meant to fit in certain areas on certain workpieces.

Shown in FIG. 21 the cup end tip flex shaft 121 formed or affixed to end of flex shaft used to find location of protruding pins in a workpiece or a protruding feature.

Shown in FIG. 22 and FIG. 23 the directly on edge tip flex shaft 122 formed or affixed to end of flex shaft used to find location of edges on workpieces and be directly over edge location on workpiece.

Shown in FIG. 24 and FIG. 25 the directly on edge sweeping radius tip flex shaft 124 formed or affixed to end of flex shaft used to find location of edges on workpieces and be directly over edge location on workpiece. This tip is meant to sweep and find the high or low reading on the measuring device.

Shown in FIG. 26 the large cone tip flex shaft 126 formed or affixed to end of flex shaft used to find the location of holes on workpieces.

Shown in FIG. 27 the inverted cone tip flex shaft 127 formed or affixed to end of flex shaft used to find location of protruding features on a workpiece.

Shown in FIG. 28 the bar shaped disk tip flex shaft 128 formed or affixed to end of flex shaft used to find locations of workpiece features and allow measurements to be detected.

Shown in FIG. 29 the vee shaped tip flex shaft 129 formed or affixed to end of flex shaft used to find center location on workpieces. The vee shape establishes 2 contact points on a workpiece to find a center location. This attachment is mostly used on round workpieces.

Shown in FIG. 30 and FIG. 31 the polygon tip flex shaft 130 has the flex shaft and or tip shaped as a polygon. May be used to measure or find location with a flex shaft shaped as a polygon. A polygon shape such as a square, or hexagon may be used.

Shown in FIG. 32 the reduced areas on reduced area flex shaft 132 may be used to allow more flex in the shaft.

Shown in FIG. 33 the large shank flex shaft 133 large shank can be combined pieces or a single formed piece may be combined with different tips for added functions used to fit in a large machine tool holder.

Shown in FIG. 34 the reduced flex shaft 134 has a reduced middle area to allow flexing in the middle area of flex shaft. It can be formed in one piece or more and pieces can be different combined materials.

I claim:

1. A flex shaft locating device comprising:
a flex shaft having a straight or curved axis and an overall length;
a mounting arm assembly or single piece mounting arm with an attaching mount affixed to flex shaft directly or indirectly;
a mounting arm assembly or single piece mounting arm with an attaching mount affixed to a measuring device; and
a measuring device affixed in an attaching mount and held in contact with a flex shaft.

2. A device in accordance to claim 1, wherein the flex shaft being used has material properties allowing the shaft to flex when shaft comes into contact with a workpiece and return back to the same repeatable position for measurement purpose.

3. A device in accordance to claim 1, wherein the device is mounted in a machine tool to establish workpiece location.

4. A device in accordance to claim 1, wherein the measurements are detected by the different types of measuring and or detection devices.

5. A device in accordance to claim 1, wherein the device is used with all the forms and types of flex shafts and attachments.

6. A device in accordance to claim 1, wherein the fasteners are loosened or tightened to adjust the position of the measuring device in relation to the flex shaft.

7. A device in accordance to claim 1, wherein the device is configured to allow more adjustment of position or adjustment of runout.

8. A device in accordance to claim 1, wherein the device and or parts are formed in one piece or more and pieces can be different combined materials.
